(19) United States
(12) Patent Application Publication
(10) Pub. No.: US 2019/0331228 A1
(43) Pub. Date: Oct. 31, 2019

(54) Fluid Manifold

(71) Applicant: Michael R. Bowman, Spokane Valley, WA (US)

(72) Inventor: Michael R. Bowman, Spokane Valley, WA (US)

(21) Appl. No.: 15/962,367

(22) Filed: Apr. 25, 2018

(51) Int. Cl. F16K 1/04; A01G 27/00

(52) U.S. Cl. CPC F16K 1/04; F16K 41/04; A01G 27/008

(57) ABSTRACT

A fluid manifold for distributing a source of fluid is described, and which includes a valve body having a plurality of fluid outlets which are coupled in fluid receiving communication relative to an internal cavity, and which is defined by the valve body, and a selectively adjustable valve member is received within the internal cavity of the valve body, and is further operable to meter the source of fluid delivered into the internal cavity and which then escapes the valve body by way of the plurality of fluid outlets for distribution to a predetermined destination.

### TECHNICAL FIELD

The present invention relates to a fluid manifold, and more specifically to a fluid manifold which is utilized to distribute a source of a fluid, such as water, to remote, predetermined locations, and which further provides a convenient means for controlling the precise, volumetric flow of the source of fluid to the given destinations in a manner not possible heretofore.

### BACKGROUND OF THE INVENTION

Various fluid manifold arrangements have been developed through the years, and have been in use in various industry segments. Generally speaking, these prior art fluid manifolds have been utilized to distribute a working fluid to various locations to achieve various advantages during a manufacturing or other operational process. For example, in the agricultural industry, the distribution of a source of fluid, such as water, to various plants has been accomplished, heretofore, by means of various sprinklers which have operated with various degrees of success.

While sprinklers, of various designs have operated to broadcast an irrigating fluid, such as water, to a given plant growing area, the only practical means available to control the volume of fluid delivered has been by means of either changing the type of sprinkler head being employed at the given location, or increasing or decreasing the pressure of the fluid being delivered. Further, and while drip irrigators of various types have been utilized through the years for more precise watering or supplying of irrigation fluids to a given plant area, again, the control of the volume of fluid delivered could only be achieved by either a substitution of the irrigation heads which are located adjacent to the plant being watered, or by increasing and decreasing the water pressure. Of course, ambient environmental factors may impact the supply of an appropriate amount of water. For example, drought conditions, or excessive rain, may dictate that greater amounts of water, or lesser amounts of water, as the case may be, needs to be supplied to a plant, or plant region, in order to achieve optimal growth.

Absent the almost continuous change of irrigation drip heads being employed, or the adjustment in the overall supply of water delivered, there is presently no convenient means available to optimize the delivery of a source of fluid, such as irrigating water, to plants that are being grown in large numbers. This problem is somewhat exacerbated when plants are grown under hydroponic conditions, and which require a much closer control of the amount of water being supplied to the plant. Those skilled in the art will recognize that in many hydroponic operations, irrigation water may further include various nutrients and other minerals. Using the various hydroponic methodologies which are available, it will be understood that various plants may be grown with only their roots exposed to this water/mineral solution, or in an environment where the roots may be supported by an inert medium such as gravel, perlite or the like.

An improved means for precisely delivering a source of fluid such as when a user is engaged in the hydroponic growth of various plants is the subject matter of the present invention.

### SUMMARY OF THE INVENTION

A first aspect of the present invention relates to a fluid manifold which includes a valve body defining an internal cavity which is coupled in fluid receiving relation relative to a source of fluid to be distributed, and wherein the valve body further includes a plurality of fluid outlets which are coupled in fluid receiving communication relative to the internal cavity thereof; and a selectively adjustable valve member which is received within the internal cavity of the valve body, and which further is selectively moveable relative to the internal cavity so as to meter the source of fluid delivered into the internal cavity of the valve body, and which then escapes the valve body, by way of the plurality of fluid outlets, for distribution to a predetermined destination.

Another aspect of the present invention relates to a fluid manifold which includes an elongated, generally cylindrically shaped main body having a first end which is releasably coupled with a source of fluid to be distributed, and an opposite second end, and wherein the cylindrically shaped main body has an exterior facing surface, and an interior facing surface, and wherein the interior facing surface defines, at least in part, an internal cavity having a predetermined cross section dimension, and which extends from the second end of the cylindrically shaped main body, and in the direction of the first end thereof, and wherein the interior facing surface further defines a valve seat which is located in an upstream position relative to the first end of the valve body, and which further communicates in fluid flowing relation relative to the internal cavity of the valve body, and further has a cross sectional dimension which is less than the cross sectional dimension of the internal cavity of the valve body, and wherein a plurality of fluid outlets are made integral with the valve body, and define individual fluid passageways which extend from the internal cavity of the valve body to a distal end of each of the fluid outlets; a manifold cap which releasably cooperates with the second end of the valve body, and which further has an inside and outside facing surfaces, and a peripheral and circumscribing sidewall, and wherein the circumscribing sidewall matingly cooperates with the exterior facing surface of the valve body at the second end thereof, and wherein a threaded aperture is formed in the manifold cap, and extends between the inside and outside facing surfaces thereof; and a selectively adjustable valve member having an elongated main body with a first end, which is received within the internal cavity of the valve body, and which further cooperates with the valve seat, and when appropriately positioned, meters the source of fluid into the internal cavity of the valve body, and an opposite, second end which is located externally relative to the manifold cap, and the valve body, and which further includes a threaded region near the second end thereof, and which matingly, and threadably cooperates with the threaded aperture formed in the manifold cap, and wherein a rotational force applied to the second end of the valve member is effective to threadably adjust the first end of the valve member relative to the valve seat so as to cause an effective metering of the source of fluid into the internal cavity of the valve body, and the delivery of the source of fluid to each of the fluid outlets for subsequent delivery to predetermined individual destinations.

These and other aspects of the present invention will be discussed in greater detail hereinafter.

### BRIEF DESCRIPTION OF THE DRAWINGS

The preferred embodiments of the invention are described below, with reference to the following accompanying drawings.

FIG. 1 is a side elevation view of a first form of the fluid manifold of the present invention.

FIG. 2 is a partially exploded, plan view of a second form of the fluid manifold of the invention.

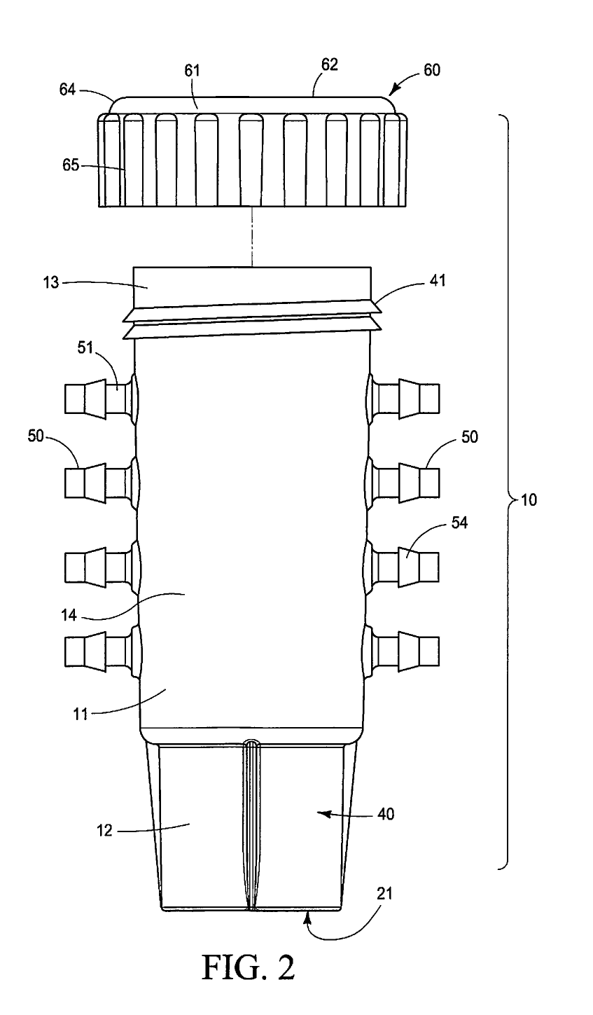

FIG. 3 is an exploded, side elevation view of the first form of the fluid manifold as seen in FIG. 1.

FIG. 4 is a first, transverse, vertical, sectional view of first form of the fluid manifold of the present invention, and which shows a valve member located in a first operational position.

FIG. 5 is a second, transverse, vertical, sectional view of the first form of the fluid manifold of the present invention, and which shows a valve member in a second operational position.

FIG. 6 is a transverse, vertical, sectional view of the second form of the fluid manifold of the present invention.

FIG. 7 is a top, plan view of the first form of the fluid manifold of the present invention.

FIG. 8 is a bottom, plan view of the present invention.

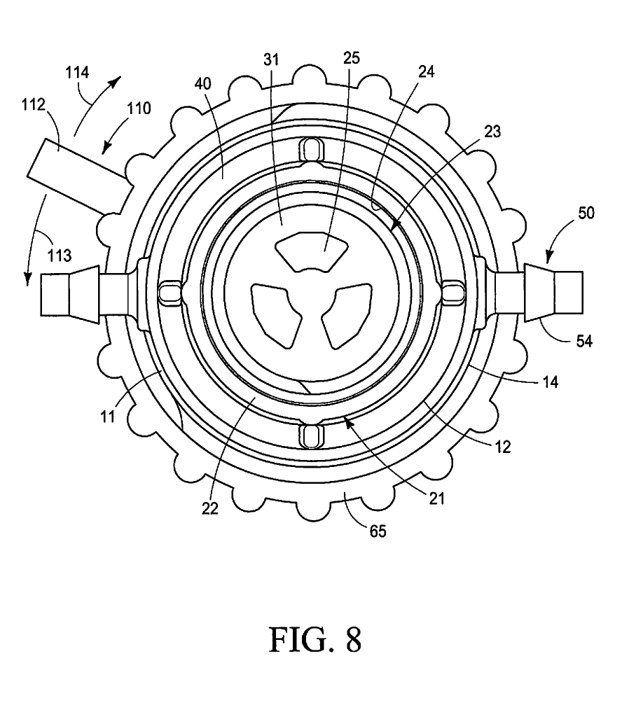

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

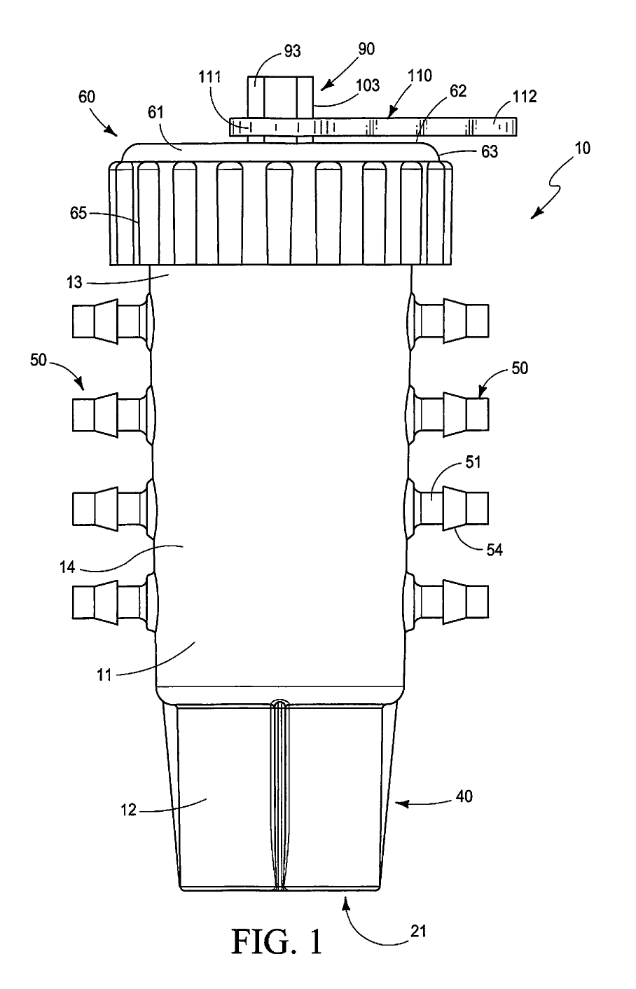

The fluid manifold of the present invention is generally indicated by the numeral 10, in FIG. 1, and following. As seen in the drawings, the fluid manifold 10 is defined, at least in part, by a valve or main body 1, and which is generally elongated, and otherwise cylindrically shaped, at least in part. The valve body 11 has a first end 12, and an opposite, and distal, second end 13. Still further, the valve body 11 has an exterior facing surface 14, and an opposite, interior facing surface 15. The first end 12 of the valve body 11 is coupled in fluid receiving relation relative to a source of fluid 16 to be distributed. The source of fluid 16 may include water, for example, or water which includes minerals and other nutrients that might be useful in a hydroponic growing operation for various types of plants (not shown). The source of fluid 16 is typically supplied by means of a threaded conduit and which is generally indicated by the numeral 17.

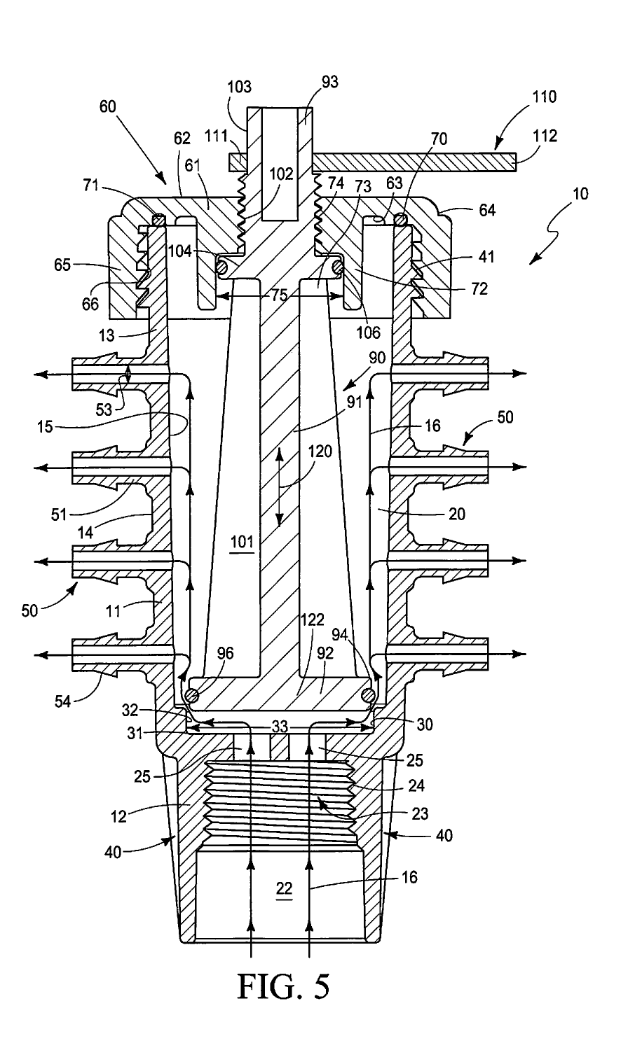

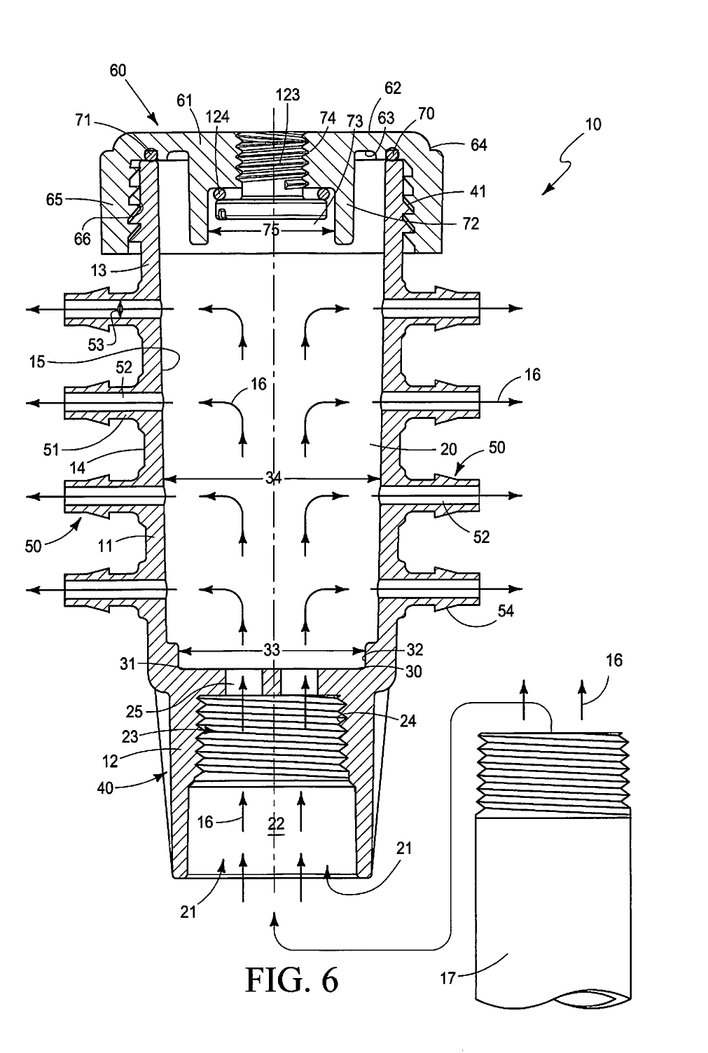

The interior facing surface 15 of the valve body 11, defines, at least in part, an internal cavity which is generally indicated by the numeral 20. As noted in the paragraphs, above, the first end 12, of the valve body 11, is releasably coupled in a downstream, fluid receiving relationship relative to the source of fluid 16 to be distributed. In this regard, the first end 12, of the valve body 11, further is defined by a female coupler cavity, and which is generally indicated by the numeral 21, and which is further formed, or otherwise defined by the first end 12, of the valve body 11. The female coupler cavity 21 is defined, at least in part, by a first, uniformly dimensioned portion 22, and which is operable to matingly receive or cooperate with the distal end of the fluid conduit 17 as seen in FIG. 6. Further, the same female coupler cavity 21 has a downstream, second portion 23, and which is defined, at least in part, by a threaded sidewall 24 which is operable to threadably mate with the distal end of the conduit 17. Positioned downstream relative to the second portion 23, of the female coupler cavity 21, is a valve seat 30, and which is positioned, therebetween, the female coupler cavity, and the internal cavity 20. The second portion 23 of the coupler cavity is disposed in fluid delivering relation relative to the internal cavity 20, by means of fluid intake passageways which are generally indicated by the numeral 25. This is best seen by reference to FIG. 5. As seen in FIG. 5, it should be understood that the valve seat 30 is positioned downstream relative to the female coupler cavity 21, and upstream relative to the internal cavity 20. The valve seat 30 is defined by a bottom surface 31. As should be appreciated by a study of FIG. 5, the fluid intake passageways 25 pass therethrough the bottom surface 31, thereby coupling the valve seat 30 in fluid receiving relation relative to the female coupler cavity 21. The valve seat 30 is defined by a continuous, circumscribing sidewall 32. As will be appreciated by a study of FIG. 5, the valve seat 30 has a given cross sectional dimension 33, which is less than the cross sectional dimension of the internal cavity 20, and which is measured along the line 34, as seen in the drawings. The purpose and function of the valve seat 30 will be discussed in greater detail, hereinafter.

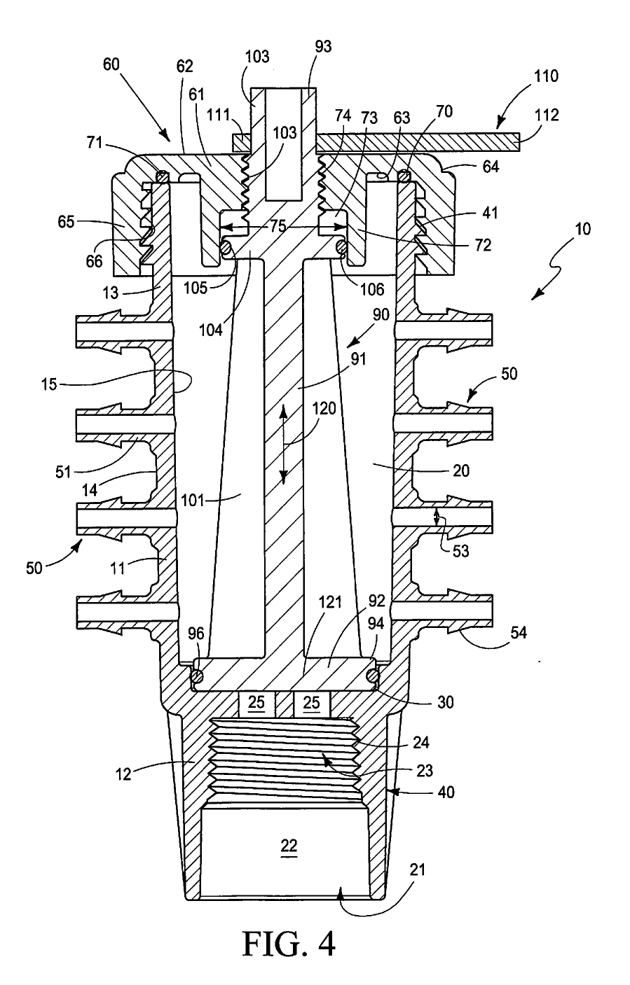

As seen in the drawings, the valve body 11, and more specifically the exterior facing surface 14 thereof, is defined, in part, by a corrugated region which is generally indicated by the numeral 40. The corrugated region 40 is seen in FIG. 1 and is illustrated as including spaced, tapering, and radially outwardly directed walls. This structure assists, to some degree, in the installation of the valve body 11 when the valve body is being threadably attached to the fluid delivery conduit 17, as earlier discussed. Of course these same spaced, tapering and radially outwardly directed sidewalls could assume other shapes, such as an elongated, and rectangular block shape which would cooperate with a wrench, for example. Still further, and as seen in FIG. 4, a threaded region 41 is formed on the exterior facing surface 14, of the second end 13 of the valve body. This threaded region 41 assists in the releasable, threadable attachment of a manifold cap, as will be described in greater detail in the paragraphs which follow. As further seen in FIG. 4, a plurality of fluid outlets or ports 50 are made integral with the valve body 11, and are further coupled in fluid receiving relation relative to the internal cavity 20 thereof. The individual fluid outlets 50, and which are illustrated as being positioned on opposite sides of the valve body 11, each include a main body 51 which extends generally radially, outwardly relative thereto. The main body 51 of each fluid outlet or port 50 defines an internal fluid passageway 52 which is coupled in fluid receiving relation relative to the internal cavity 20 of the valve body 11. Further each of the fluid passageways 52 has a given cross sectional dimension 53. In one possible form of the invention 10, the given cross sectional dimension of the respective fluid passageways 52 are the same. In another possible form of the invention 10, the cross sectional dimension of the respective fluid passageways 52 are different (not shown). This feature allows the present invention 10 to be designed so as to allow a user to distribute either a greater or lesser amounts of fluid 16 when the internal cavity 20 is supplied with the source of fluid 16. As seen in FIG. 4, the main body 51 is further defined, at least in part, by a barb-shaped exterior facing surface 54. The barb-shaped exterior surface assists in the frictional engagement with a resilient conduit, not shown, and which may be extended to a predetermined destination, such as, for example a plant receiving hydroponic treatment.

The fluid manifold 10 of the present invention includes a manifold cap 60 which releasably cooperates with the second end 13, of the valve body 11. The manifold cap 60 is defined, at least in part, by a main body 61, and which further has an exterior facing surface 62, and an opposite, interior facing surface 63. The main body 61 further has a peripheral edge 64. The exterior facing surface could include printed indicia which might indicate to a user (not shown) the direction that the selectively adjustable valve member could be turned or rotated so as to open or close the fluid manifold 10. The valve member will be discussed in greater detail, hereinafter. As seen in the attached drawings, a depending, and circumscribing sidewall 65 extends downwardly from the peripheral edge 64. The circumscribing sidewall 65 further is defined by an inwardly facing threaded region 66, and which is operable to matingly cooperate with the threaded region 41, and which is made integral with the exterior facing surface 14, and which is located at the second end 13 of the valve body 11. The manifold cap 60 is further defined, in part, by a circumscribing seal cavity 70 which is formed in a given location on the interior facing surface 63, and which further is sized so as to receive a flexible, water resilient seal, or gasket 71 therein. The circumscribing seal cavity 70 is oriented so as to position the flexible seal or gasket 71 so that it may releasably, and fluid sealably engage the second end 13 of the valve body (FIG. 4). As further seen in FIG. 4, it should be understood that the manifold cap 60 includes a depending circumscribing sidewall 72, and which is mounted on the interior facing surface 63 of the manifold cap 60, and is further positioned radially, inwardly relative to the circumscribing sidewall 65. The depending sidewall 72 defines a valve member cavity 73, and which will be discussed in greater detail, below. Formed substantially centrally relative to the main body 61 is a threaded passageway 74, and which extends between the exterior and interior facing surfaces 62 and 63, respectively. The threaded passageway 74 is operable to matingly and threadably cooperate with a portion of a valve member as will be discussed in the paragraphs, which follow. The threaded passageway 74 is received or otherwise oriented and communicates substantially centrally relative to the valve member cavity 73. As should be understood, the valve member cavity 73 has a given cross sectional dimension 75, and which is less than the cross sectional dimension 34 of the internal cavity 20. This relationship is clearly seen by reference to FIG. 4.

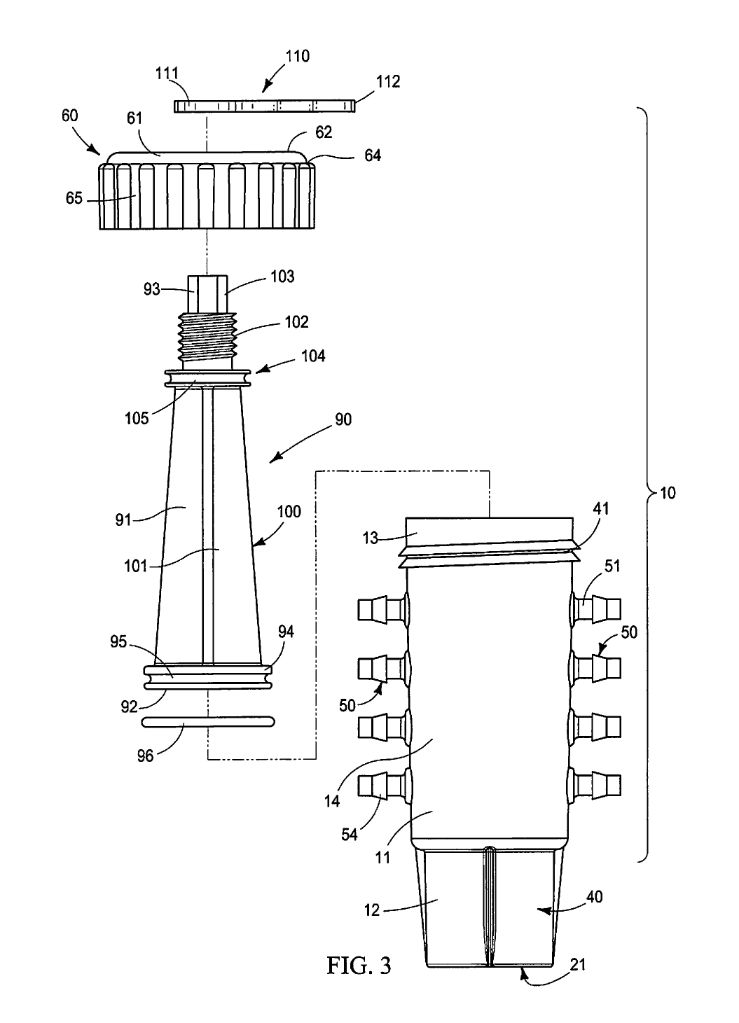

As best seen in the drawings, the fluid manifold 10 includes a selectively adjustable valve member, and which is generally indicated by the numeral 90, and which further is defined, at least in part, by an elongated main body 91. The elongated main body 91 has a first end 92, and an opposite, second end 93. As seen in FIG. 3, it should be noted that the elongated main body 91, has a reduced cross-sectional dimension when that cross-sectional dimension is measured between the first end 92, and the second end 93, respectively. As will also be seen in FIG. 3, it will be recognized that the first end 92 has a peripheral edge 94, and which has formed therein, a circumscribing, seal cavity 95. The seal cavity 95 is sized so as to receive, and secure a flexible seal 96 therein. When received in the circumscribing seal cavity 95, the flexible seal 96 is operable to movably, and sealably engage the circumscribing wall 32 which defines, at least in part, the valve seat 30. The seal 96 further operates to substantially inhibit the delivery of the source of water 16 into the internal cavity 20 of the valve body 11, when the first end 92 of the adjustable valve member 90 is operably received within the valve seat 30, and the valve member 90 is threadably advanced in a direction toward, and is received in an occluding or sealing orientation relation relative to the valve seat 30 (FIG. 4). Still further, the selectively adjustable valve member 90 includes an intermediate portion 100. As seen in the drawings, the intermediate portion 100 has a reduced cross-sectional dimension when that same cross-sectional dimension is measured between the first and second ends 92 and 93, respectively. The intermediate portion 100 includes, or is otherwise defined, at least in part, by multiple channel regions 101 which facilitate the flow of the source of water, or other fluid 16 past the valve member 90, as the water or other fluid 16 enters, or passes into the internal cavity 20 once the first end 92 is displaced from the valve seat 30 (FIG. 5). The second end 93 of the selectively adjustable valve member 90 also includes a threaded region 102 which is sized so as to matingly and threadably engage or otherwise cooperate with the threaded passageway 74, and which is formed in the manifold cap 60, as earlier described. In addition to the foregoing, and as should be understood from a study of the attached drawings, the second end 93 defines an exterior facing, tool engagement region 103. Still further, the selectively adjustable valve member 90 also includes an enlarged intermediate portion 104, and which is further located near, but in spaced relation relative to, the second end 93, and is yet further positioned within the internal cavity 20, of the valve member 11, and also within the valve member cavity 73, when the selectively adjustable valve member 90 is operably coupled to the manifold cap 60, as earlier described. Moreover, and as should be further appreciated from a study of the drawings, the enlarged intermediate portion 104 also is defined, at least in part, by a circumscribing seal cavity 105. The circumscribing seal cavity 105, is operable to receive or cooperate with a flexible seal 106 which is sized so as to be received within the valve member cavity 73. This same seal 106 is operable to impede the passage of the source of the fluid 16 into the valve member cavity 73, and thus prevents the source of fluid 16 from passing through the threaded passageway 74. This feature will be discussed in greater detail, hereinafter.

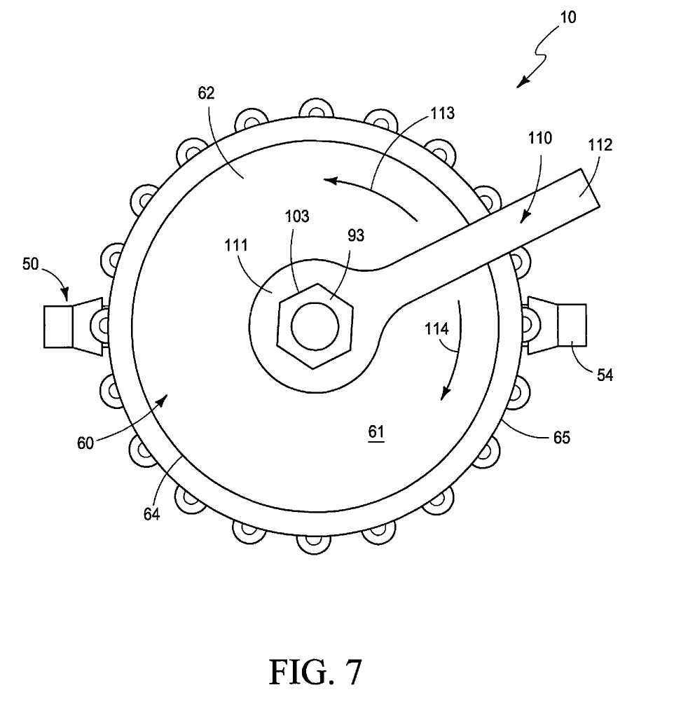

The present invention 10 includes a manifold flow adjustment tool 110, and which is operable to impart rotational force to the second end 93 of the adjustable valve member 90, and which is positioned exteriorly relative to the manifold cap 60, and the valve body 11, respectively. The manifold flow adjustment tool 110 includes an engagement member or end 111, and a force receiving end 112. In one possible form of the invention the force receiving end 112 which is square shaped (FIG. 7) could be formed with a reduced thickness dimension so that it may be used as screw driver, and which further could be employed to threadably advance a fastener 123 into occluding relation relative to the passageway 74 as seen in FIG. 6. As seen in FIG. 6 the fastener 123 secures a seal member 124 between the manifold cap 60, and the threaded fastener 123. In the configuration as seen in FIG. 6 the fastener 123 converts the present fluid manifold 10 into an arrangement where the flow of fluid is uncontrolled. The engagement member 111 matingly engages, or otherwise cooperates with the second end 93 of the selectively adjustable valve member 90, and is further operable to move the valve member 90 along a first path of rotational movement 113; or a second path of rotational movement 114 (FIG. 7). As will be appreciated from a study of the drawings the rotational path of movement or travel 113 or 114 produces a resulting linear, and longitudinally oriented path of movement 120, for the selectively adjustable valve member 90 (FIGS. 4 and 5). In this regard, rotation of the selectively adjustable valve member 90 in a first direction 113, causes the first end 92 to be positioned in a first operational orientation 121 where it is sealingly received within the valve seat 30 (FIG. 4). Still further, rotation of the selectively adjustable valve member 90 along a second path of rotation or movement 114 threadably withdraws, or moves the first end 92 along the path of movement 120 to a second, operational orientation 122, and which is displaced from the valve seat 30, thereby allowing the source of water or other fluid 16 to pass into the internal cavity 20 of the valve body 11, and thereby travel to, and then pass along, and out through, the plurality of fluid outlets 50, so that the source of fluid 16 may be delivered at predetermined, remote locations. Of course, the selective adjustment of the valve member 90 relative to the valve seat 30 results in a controllable flow of the source of fluid 16 within the internal cavity 20 so as to allow a user to meter the precise flow or volume of fluid 16 which is necessary for their desired end use.

### OPERATION

The operation of the described embodiment of the present invention 10 is believed to be readily apparent, and is briefly summarized at this point. In its broadest aspect, the fluid manifold 10 of the present invention includes a valve body 11 which defines an internal cavity 20, and which further is coupled in fluid receiving relation relative to a source of fluid 16 be distributed. The valve body 11 further includes a plurality of fluid dispensing outlets 50 which are coupled in fluid receiving communication relative to the internal cavity 20, thereof. The fluid manifold 10 also includes a selectively adjustable valve member 90 which is received within the internal cavity 20, of the valve body 11, and which further is selectively movable relative to the internal cavity 20, so as to meter the source of fluid 16, and which is delivered into the internal cavity 20 of the valve body 11, and which then escapes from the valve body 11 by way of the respective fluid outlets 50 for distribution to predetermined remote destinations.

The fluid manifold 10 of the present invention, as noted above, includes a valve body 11 which is elongated in shape, and which further has a given length dimension. The valve body 11 also has opposite first and second ends 12 and 13, respectively. The internal cavity 20 has a predetermined length dimension which is at least a preponderance of the length dimension of the valve body 11. Still further, it should be understood that the valve member 90 has an elongated shape, and further has opposite, first and second ends 92 and 93, respectively. The valve member 90, as seen in FIGS. 4 and 5, is at least partially, and longitudinally movable relative to the internal cavity 20 of the valve body 11. As seen in the drawings, the first end 12 of the valve body 11 is releasably coupled in a downstream, fluid receiving relationship relative to the source of fluid 16 to be distributed. Still further, the first end 12 of the valve body 11 defines a valve seat 30, and which is positioned in a downstream, fluid-flowing position relative to the first end 12, of the valve body 11, and which is further located within the internal cavity 20 thereof. The valve seat 30 has a predetermined cross-sectional dimension 33, and which is less than the cross-sectional dimension 34 of the internal cavity 20 of the valve body 11. The first end 92 of the valve member 90 has a peripheral edge 94 which mounts a resilient seal 96, and which further movably and sealably engages the valve seat 30. In addition to the foregoing, the resilient seal 96 substantially inhibits the delivery of the source of water or fluid 16 into the internal cavity 20 of the valve body 11 when the first end 92 of the valve number 90 is received within the valve seat 30 (FIG. 4).

The fluid manifold 10 of the present invention further includes a detachable manifold cap 60 which is releasably coupled with the second end 13, of the valve body 11, and which further defines a centrally disposed, and threaded passageway 74. The threaded passageway 74 threadably and matingly cooperates, at least in part, with the second end 93 of the valve member 90. As should be understood, a predetermined rotational force applied to the second end 93 of the valve member 90 is effective to either longitudinally advance 120, the first end 92, of the valve member 90 in a direction toward the valve seat 30 (FIG. 4); or longitudinally withdraws or moves the first end 92 of the valve member 90 in a direction away from the valve seat 30 (FIG. 5). In addition to the foregoing, a valve member cavity 73 is defined by the detachable manifold cap 60, and is further oriented substantially concentrically about the threaded passageway 74, and is further located within the internal cavity 20 of the valve body 11. The second end 93 of the valve member 90 movably and sealably cooperates with the valve member cavity 73 so as to substantially prohibit the source of fluid 16 which is entering into the internal cavity 20 of the valve body 11 from traveling, and then passing, at least in part, through the threaded passageway 74, and then escaping from the internal cavity 20, of the valve body 11. As earlier discussed, the detachable manifold cap 60 has an inside facing surface 63. Still further a fluid seal 71 is mounted on the inside facing surface 63 of the detachable manifold cap 60, and is further operable to sealably engage the second end 13 of the valve body 11. Still further, and in a second possible form of the invention 10 as seen in FIG. 6, a threaded fastener 123 is provided and which is threadably advanced into the threaded passageway 74 which is defined by the detachable manifold cap 60 following the removal of the valve member 90, from the internal cavity 20, of the valve body 11, and the threadable detachment of the second end 93, of the valve body 90 from the detachable manifold cap 60 so as to convert the valve body 11 into an uncontrolled fluid manifold for the distribution of the source of fluid 16. In one particular form of the invention the respective fluid passageway 52 which are defined by each of the fluid outlets 50 have a predetermined cross sectional dimension which is the same (FIG. 6). In another possible form of the invention 10 the respective fluid passageways 52 which are defined by each of the fluid outlets 50 have a predetermined cross sectional dimension which is different (not shown). In one possible form of the invention 10 a seal 124 is provided and which is positioned between a threaded fastener 123, and the manifold cap 60 (FIG. 6).

Therefore, it will be seen that the present invention 10 provides a convenient means whereby a user may precisely meter the amount of fluid 16 being delivered by the fluid manifold 10 to given, predetermined locations, and which are coupled in downstream, fluid flowing relation relative to the plurality of fluid outlets or ports 50, and which are made integral with the valve body 11. The present invention 10 is easy to utilize, is controllable by means of a manifold flow adjustment tool 110, is reliable, and is further operable to provide predetermined volumes of fluid 16 in a manner not possible, heretofore.

In compliance with the statute the invention has been described in language more or less specific as to structural and methodological features. It is to be understood, however, that the present invention is not limited to the specific features shown and described, since the means herein disclosed comprise preferred forms of putting the invention into effect. The invention is, therefore, claimed in any of its several forms or modifications within the proper scope of the appended claims appropriately interpreted in accordance with the doctrine of equivalence.

I claim:

1. A fluid manifold, comprising:
a valve body defining an internal cavity which is coupled in fluid receiving relation relative to a source of fluid to be distributed, and wherein the valve body further includes a plurality of fluid outlets which are coupled in fluid receiving communication relative to the internal cavity thereof; and
a selectively adjustable valve member which is received within the internal cavity of the valve body, and which further is selectively moveable relative to the internal cavity so as to meter the source of fluid delivered into the internal cavity of the valve body, and which then escapes the valve body, by way of the plurality of fluid outlets, for distribution to a predetermined destination.

2. A fluid manifold as claimed in claim 1, and wherein the valve body is elongated, and has a given length dimension, and wherein the valve body further has opposite first and second ends, and wherein the internal cavity has a length dimension which is at least a preponderance of the length dimension of the main body.

3. A fluid manifold as claimed in claim 2, and wherein valve member is elongated, and has opposite, first and second ends, and which further is at least partially, and longitudinally moveable relative to the internal cavity of the valve body, and wherein the first end of the valve member is located within the internal cavity of the valve body, and the second end of valve member is located externally relative to the valve body.

4. A fluid manifold as claimed in claim 3, and wherein the first end of the valve body is releasably coupled in a downstream fluid receiving relationship relative to the source of fluid to be distributed, and further defines a valve seat which is positioned in downstream position relative to of the first end of the valve body, and within the internal cavity thereof, and wherein the internal cavity of the valve body has a predetermined cross sectional dimension, and the valve seat has a cross sectional dimension which is less than the cross sectional dimension of the internal cavity of the valve body.

5. A fluid manifold as claimed in claim 4, and wherein the first end of the valve member has a peripheral edge which mounts a resilient seal, and which further is sized so as to moveably and sealably engage the valve seat, and further the resilient seal substantially inhibits the delivery of the source of water into the internal cavity of the valve body when the first end of the valve member is received within the valve seat.

6. A fluid manifold as claimed in claim 5, and further comprising:
a detachable manifold cap which is releasably coupled with the second end of the valve body, and which further defines a centrally disposed, and threaded passageway which threadably, and matingly cooperates, at least in part, with the second end of the valve member, and wherein a predetermined rotational force applied to the second end of the valve member is effective to either longitudinally advance the first end of the valve member in a direction toward the valve seat, or longitudinally move the first end of the valve member in a direction away from the valve seat.

7. A fluid manifold as claimed in claim 6, and wherein a valve member cavity is defined by the detachable manifold cap, and is further oriented concentrically about the threaded passageway, and is further located within the internal cavity of the valve body, and wherein the second end of the of the valve member moveably, and sealably cooperates with the valve member cavity so as to substantially prohibit the source of fluid which is entering into the internal cavity of the valve body, from traveling, and then passing, at least in part, through the threaded passageway, and escaping from the internal cavity of the valve body.

8. A fluid manifold as claimed in claim 7, and wherein the valve body has opposite sides, and wherein the plurality of fluid outlets are oriented in predetermined, spaced relation, one relative to the other, and on the opposite sides of the valve body.

9. A fluid manifold as claimed in claim 8, and wherein the detachable manifold cap has an inside facing surface, and wherein a fluid seal is mounted on the inside facing surface of the detachable manifold cap, and is operable to sealably engages the second end of the valve body.

10. A fluid manifold as claimed in claim 6, and further comprising:
a threaded fastener which is threadably advanced into the threaded passageway defined by the detachable manifold cap following the removal of the valve member from the internal cavity of the valve body, and the threadable detachment of the second end of the valve body from the detachable manifold cap so as to convert the valve body into an uncontrolled fluid manifold for the distribution of the source of fluid.

11. A fluid manifold, comprising:
an elongated, generally cylindrically shaped valve body having a first end which is releasably coupled with a source of fluid to be distributed, and an opposite second end, and wherein the cylindrically shaped valve body has an exterior facing surface, and an interior facing surface, and wherein the interior facing surface defines, at least in part, an internal cavity having a predetermined cross section dimension, and which extends from the second end of the cylindrically shaped valve body, and in the direction of the first end thereof, and wherein the interior facing surface further defines a valve seat which is located in an upstream position relative to the first end of the valve body, and which further communicates in fluid flowing relation relative to the internal cavity of the valve body, and further has a cross sectional dimension which is less than the cross sectional dimension of the internal cavity of the valve body, and wherein a plurality of fluid outlets are made integral with the valve body, and define individual fluid passageways which extend from the internal cavity of the valve body to a distal end of each of the fluid outlets;
a manifold cap which releasably cooperates with the second end of the valve body, and which further has an inside and outside facing surfaces, and a peripheral and circumscribing sidewall, and wherein the circumscribing sidewall matingly cooperates with the exterior facing surface of the valve body at the second end thereof, and wherein a threaded aperture is formed in the manifold cap, and extends between the inside and outside facing surfaces thereof; and
a selectively adjustable valve member having an elongated main body with a first end, which is received within the internal cavity of the valve body, and which further cooperates with the valve seat, and when appropriately positioned, meters the source of fluid into the internal cavity of the valve body, and an opposite, second end which is located externally relative to the manifold cap, and the valve body, and which further includes a threaded region near the second end thereof, and which matingly, and threadably cooperates with the threaded aperture formed in the manifold cap, and wherein a rotational force applied to the second end of the valve member is effective to threadably adjust the first end of the valve member relative to the valve seat so as to cause an effective metering of the source of fluid into the internal cavity of the valve body, and the delivery of the source of fluid to each of the fluid outlets for subsequent delivery to predetermined individual destinations.

12. A fluid manifold as claimed in claim 11, and wherein the respective fluid passageways defined by each of the fluid outlets have a predetermined cross sectional dimension which is the same.

13. A fluid manifold as claimed in claim 11, and wherein the respective fluid passageways defined by each of the fluid outlets have a predetermined cross sectional dimension which is different.

14. A fluid manifold as claimed in claim 11, and wherein the source of fluid is delivered to the first end of the valve body by way of conduit having a distal end, and wherein the first end of the valve body releasably, couples with the distal end of the conduit.

15. A fluid manifold as claimed in claim 14, and wherein a fluid seal is mounted on the inside facing surface of the manifold cap and operates to sealably engage the second end of the valve body, and wherein the circumscribing sidewall of the manifold cap releasably, and threadably engages the second end of the valve body.

16. A fluid manifold as claimed in claim 15, and wherein a valve member cavity is made integral with the inside facing surface of the manifold cap, and is oriented concentrically about the threaded passageway, and is further located within the internal cavity of the valve body, and wherein the second end of the of the valve member moveably, and sealably cooperates by way of a flexible seal with the valve member cavity so as to substantially prohibit the source of fluid which is entering into the internal cavity of the valve body, from traveling and then passing, at least in part, through the threaded passageway and escaping from the internal cavity of the valve body.

17. A fluid manifold as claimed in claim 16, and wherein the second end of the valve member has an exterior facing surface having a given shape, and wherein the rotational force applied to the second end of the valve member is applied by means of a tool which releasably and matingly cooperates with the exterior facing surface of the second end of the valve member so as to transmit a clockwise or counter-clockwise rotational force to the valve member, and which is effective to meter the source of fluid into the internal cavity of the valve body.

18. A fluid manifold as claimed in claim 17, and wherein the first end of the valve member has a peripheral edge which mounts a resilient seal, and which further is sized so as to moveably and sealably engage the valve seat, and further substantially inhibits the delivery of the source of water into the internal cavity of the valve body when the first end of the valve member is threadably advanced toward, and received within, the valve seat.

19. A fluid manifold as claimed in claim 18, and further comprising:
a threaded fastener which can be threadably advanced into the threaded passageway defined by the manifold cap following the removal of the valve member from the internal cavity of the valve body, and the threadable detachment of the second end of the valve body from the manifold cap so as to convert the valve body into an uncontrolled manifold for the distribution of the source of fluid.

20. A fluid manifold as claimed in claim 19, and wherein a fluid seal is disposed between the threaded fastener, and the manifold cap.
